(19) United States
(12) Patent Application Publication
(10) Pub. No.: US 2006/0260911 A1
(43) Pub. Date: Nov. 23, 2006

(54) Rapid reconfigurable servo correction cone conveyor

(75) Inventors: Todd A. Eckert, Huntington, IN (US); Steve Buffmyer, Oxford, MI (US); Carol L. Shuttleworth, Huntington, IN (US); Gregory C. Stroud, Huntington, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(73) Assignee: SHUTTLEWORTH, INC., Huntington, IN (US)

(21) Appl. No.: 10/549,439

(22) PCT Filed: Mar. 17, 2004
(86) PCT No.: PCT/US04/08021

§ 371 Date: Jul. 26, 2006

Related U.S. Application Data
(60) Provisional application No. 60/455,772, filed on Mar. 18, 2003.

(51) Int. Cl. B65G 13/06

(52) U.S. Cl. 198/784; 198/780; 198/781.06

(57) ABSTRACT

Apparatus and methods for conveying products to be wrapped. In one embodiment, a conveying section is located upstream of a product infeed and wrapping mechanism. The conveying section includes rollers for conveying the products. The roller shafts are controlled in three different groups by an electronic controller. In one embodiment the first group comprises slippable rollers, and the two downstream conveying sections include fixed rollers. The fixed rollers are electronically controlled to substantially the same speed, but with slight phase or positional differences therebetween. In another embodiment of the present invention, a conveyor includes a right side drive on the right side of the conveying path, and a left side drive on the left side of the conveying path. The conveyor includes a plurality of roller shafts which have a single driving wheel on one end. The roller shafts can be driven by either the right drive or the left drive by simply removing the shaft, swapping it over end for end, and reinserting it with the drive wheel being driven by the other drive.

### CROSS REFERENCE TO RELATED APPLICATION

This application claims priority to U.S. provisional patent application Ser. No. 60/455,772, filed Mar. 18, 2003, which is incorporated herein by reference.

### FIELD OF THE INVENTION

The present invention relates to apparatus and methods for conveying products, and in particular apparatus and methods for conveying products that are to be wrapped.

### BACKGROUND OF THE INVENTION

There is often a need to provide careful spacing between mass produced products during their manufacture. For example, some products are wrapped by automated wrapping systems prior to final packaging and shipment of the products. It is desirable to minimize the amount of wrapping media that is wasted during the wrapping process. Careful and precise placement and presentation of the product to the wrapping system permits a reduction in the amount of wrapping media being wasted, with a commensurate decrease in wrapping costs.

In yet other applications a quantity of mass produced products need to be provided in an accurate and predetermined pattern for subsequent processing. During previous processing, the products can be spaced on a conveyor in a random fashion. It may be desirable to accumulate the products with a first, rough and/or simple spacing, and subsequently convey them for further processing in a second, more accurately controlled spacing pattern.

What is needed are improvements in the apparatus and methods by which products are accurately spaced by a conveying system. The various embodiments of the present invention do this in novel and unobvious ways.

### SUMMARY OF THE INVENTION

One embodiment of the present invention relates to a method for conveying products to a downstream conveyor, comprising providing a first conveyor having a plurality of roller shafts. The embodiment also includes driving a first group of roller shafts operating at a first speed and a second group of roller shafts operating at a second speed. The embodiment also includes driving a third group of roller shafts downstream of and proximate to the second group. The embodiment also includes altering the driving of the third group relative to the driving of the second group so as to change the spacing between adjacent products.

Another embodiment of the present invention relates to a conveyor for conveying products along a conveying path, comprising a first support member and a second support member. The embodiment also includes a first driving member supported by the first support member and the second driving member supported by the second support member. The embodiment also includes a third driving member supported by the first support member, wherein the second driving member overlaps a portion of the first driving member and the second length overlaps a portion of the third driving member. Preferably, the three driving members are driven independently.

Another embodiment of the present invention relates to a conveyor for conveying a product comprising a first driving chain being driven in a first manner. The embodiment also includes a second driving chain second chain being driven in a second manner different than the first manner. The embodiment also includes a roller shaft having a driving wheel proximate to one end of the shaft. The embodiment also includes at least one roller driven by the shaft. The conveyor is adapted and configured to rotatably support the roller shaft such that the driving wheel is capable of engaging the first chain and driving the roller shaft in the first manner, and the conveyor is adapted and configured to rotatably support the roller shaft such that the driving wheel is capable of engaging the second chain and driving the roller shaft in the second manner.

Yet another embodiment of the present invention relates to a conveyor for conveying a product to a first section of roller shafts driving at least one slippable roller which slips at a first predetermined torque, and a second portion of the first section driving at least one roller which slips at a second predetermined torque, the second torque being different than the first torque. In still further embodiment there is a second section of roller shafts, each driving at least one roller fixed to a corresponding shaft of the second section. Some embodiments also include means for stopping a product on the second portion.

These and other aspects of the various embodiments will be apparent from the drawings, description, and claims to follow.

### BRIEF DESCRIPTION OF THE DRAWINGS

FIG. 1 is a side elevational view of a conveying system according to one embodiment of the present invention.

FIG. 2A is a top view of the apparatus of FIG. 1.

FIG. 2B is a top schematic representation of the conveying apparatus of FIG. 2A.

FIG. 3 is a partial cross sectional view of the apparatus of FIG. 2A as taken along line 3-3 of FIG. 2A.

FIG. 4 is a partial cross sectional view of the apparatus of FIG. 2A as taken along line 4-4 of FIG. 2A.

FIG. 5 is a partial cross sectional view of the apparatus of FIG. 1 as taken along line 5-5 of FIG. 2A.

FIG. 6 is an end elevational view of the apparatus of FIG. 1.

FIG. 7 is a top schematic representation of a conveying apparatus according to another embodiment of the present invention.

FIG. 8 is a top schematic representation of a conveying apparatus according to another embodiment of the present invention.

FIG. 9 is a top schematic representation of a conveying apparatus according to another embodiment of the present invention.

FIG. 10 is a top schematic representation of a conveying apparatus according to another embodiment of the present invention.

FIG. 11 is a side elevational view of a roller shaft according to one embodiment of the present invention.

FIG. 12 is a side elevational view of a roller shaft according to another embodiment of the present invention.

FIG. 13 is a top and right-side photograph of a conveying apparatus according to another embodiment of the present invention.

FIG. 14 is a top, right-side photograph of a portion of the apparatus of FIG. 13.

FIG. 15 is a top view photograph of a portion of the apparatus of FIG. 13.

FIG. 16 is a top perspective view of a photograph of other portions of the apparatus of FIG. 13.

FIG. 17 is a top perspective view of a photograph of other portions of the apparatus of FIG. 13.

FIG. 18 is a top perspective view of a photograph of other portions of the apparatus of FIG. 13.

FIG. 19 is a side view of a photograph of an apparatus which includes the apparatus of FIG. 13.

FIG. 20 is a side view of a photograph of a portion of the apparatus of FIG. 19.

FIG. 21 is a flow chart of a controller algorithm according to one embodiment of the present invention.

FIG. 22 is a continuation of the flowchart of FIG. 21.

FIG. 23 is a continuation of the flowchart of FIG. 22.

FIG. 24 is a continuation of the flowchart of FIG. 23.

FIG. 25 is a top schematic representation of a conveying apparatus according to another embodiment of the present invention.

FIG. 26 is a top schematic representation of the conveying apparatus of FIG. 25.

### DESCRIPTION OF THE PREFERRED EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

This application incorporates by reference U.S. Pat. No. 6,516,940, LOW ELECTROSTATIC DISCHARGE CONVEYOR; U.S. Pat. No. 6,193,047, ERGONOMIC WORKSTATION CONVEYOR APPARATUS AND METHOD; U.S. Pat. No. 6,098,786, SLIPPABLE ROLLER CONVEYOR FOR A CLEAN ROOM; and U.S. Pat. No. 3,951,255, CONVEYOR WITH DRIVEN SLIPPABLE ROLLERS; all of the foregoing being incorporated herein by reference.

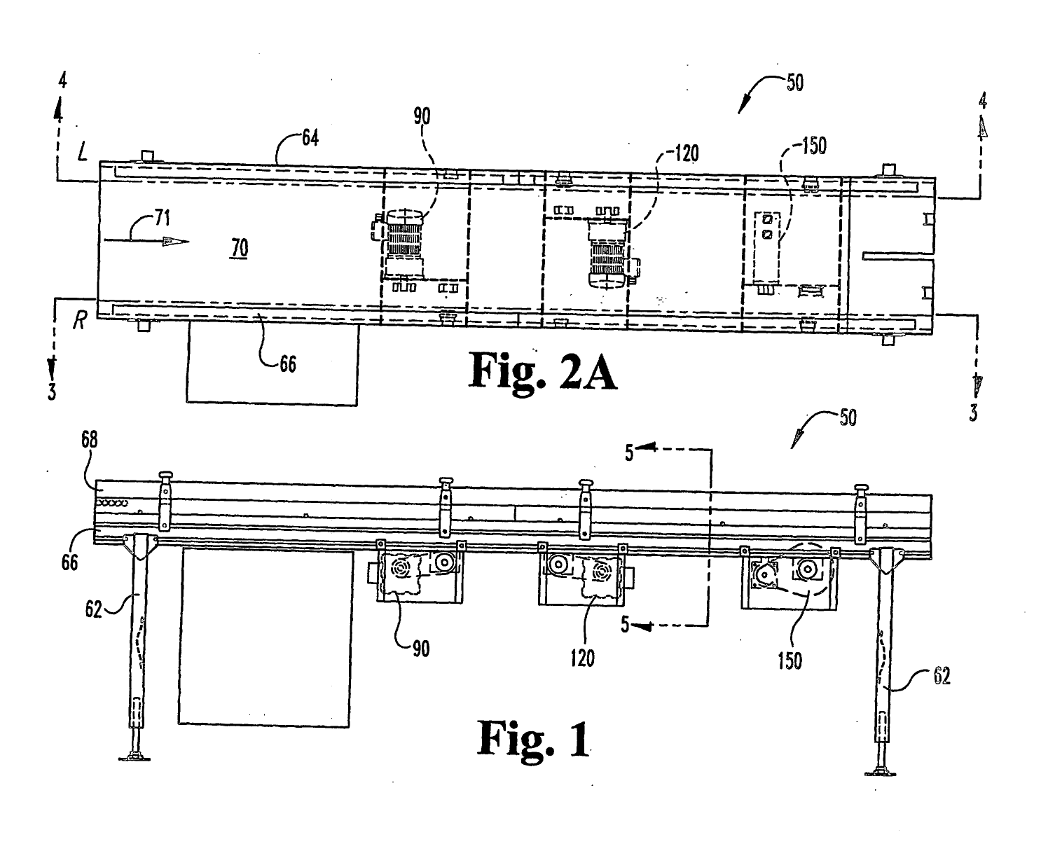

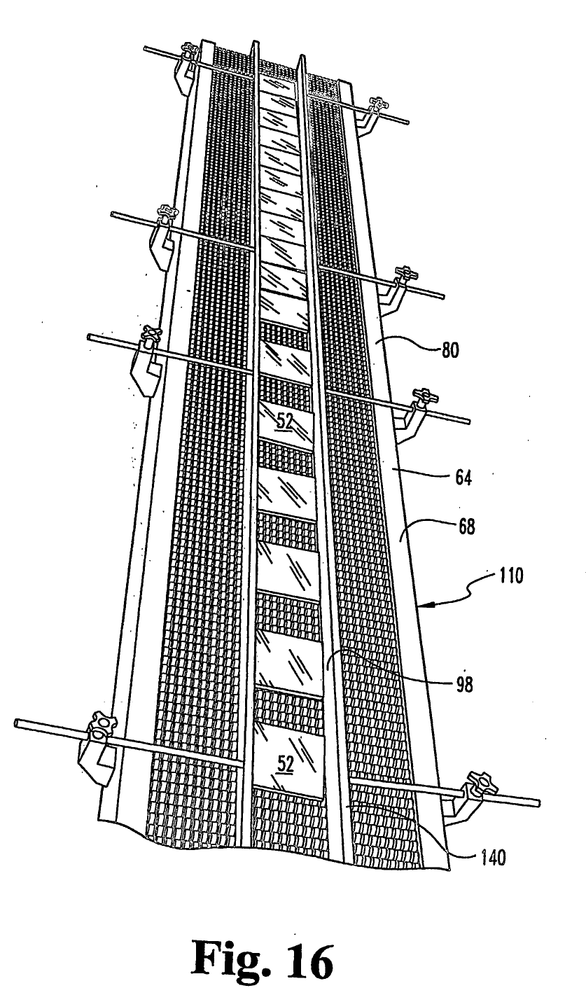

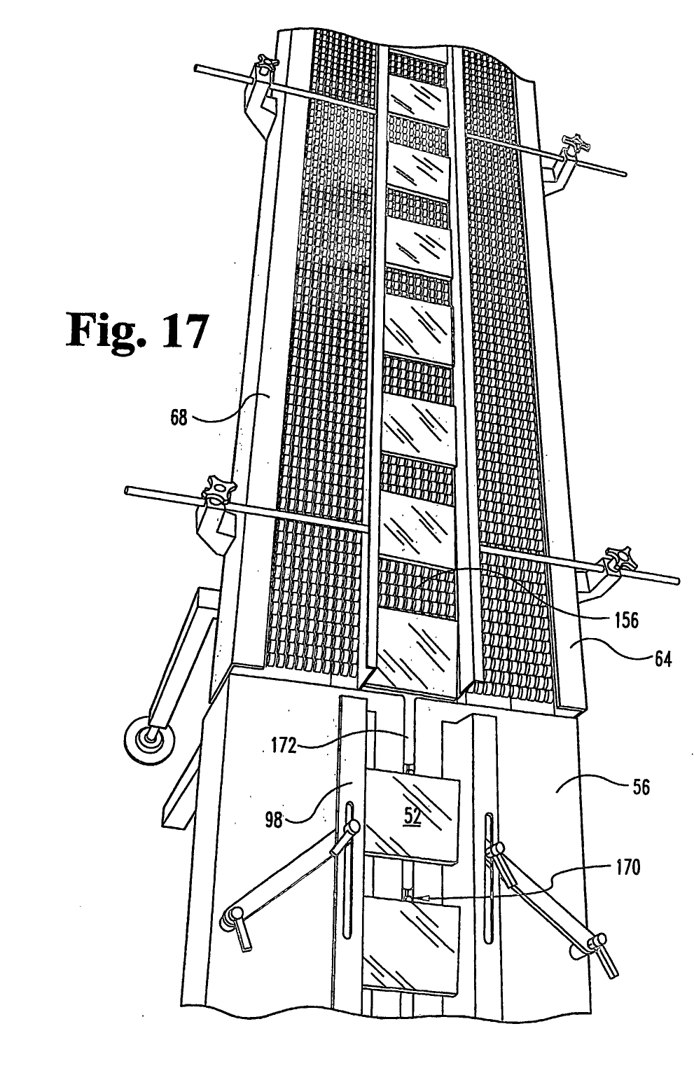

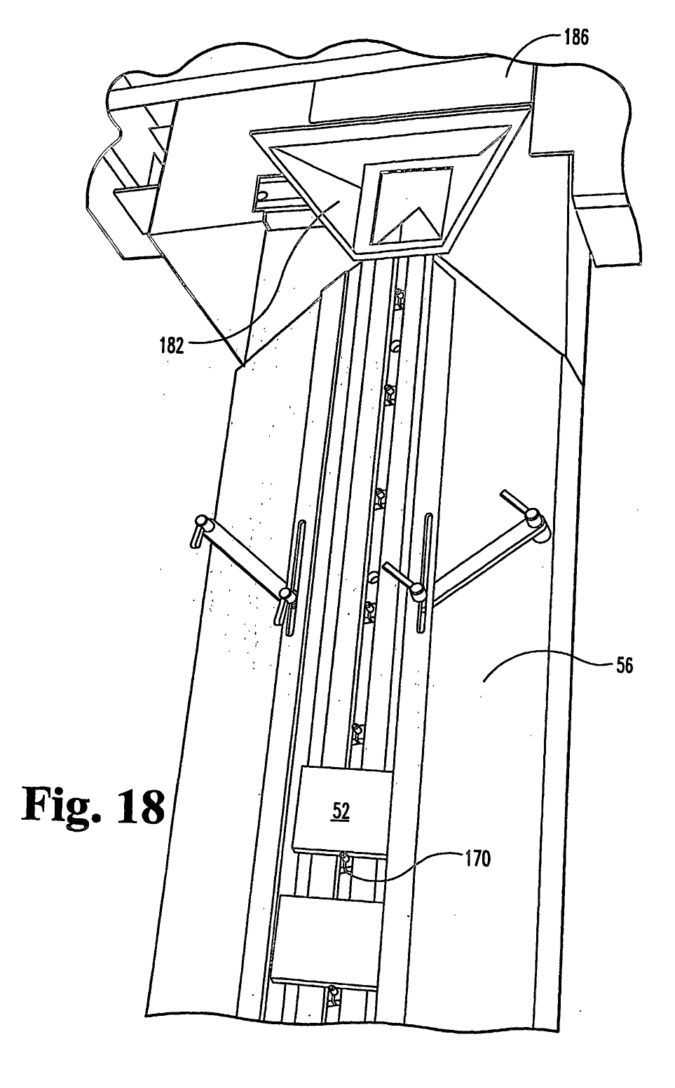

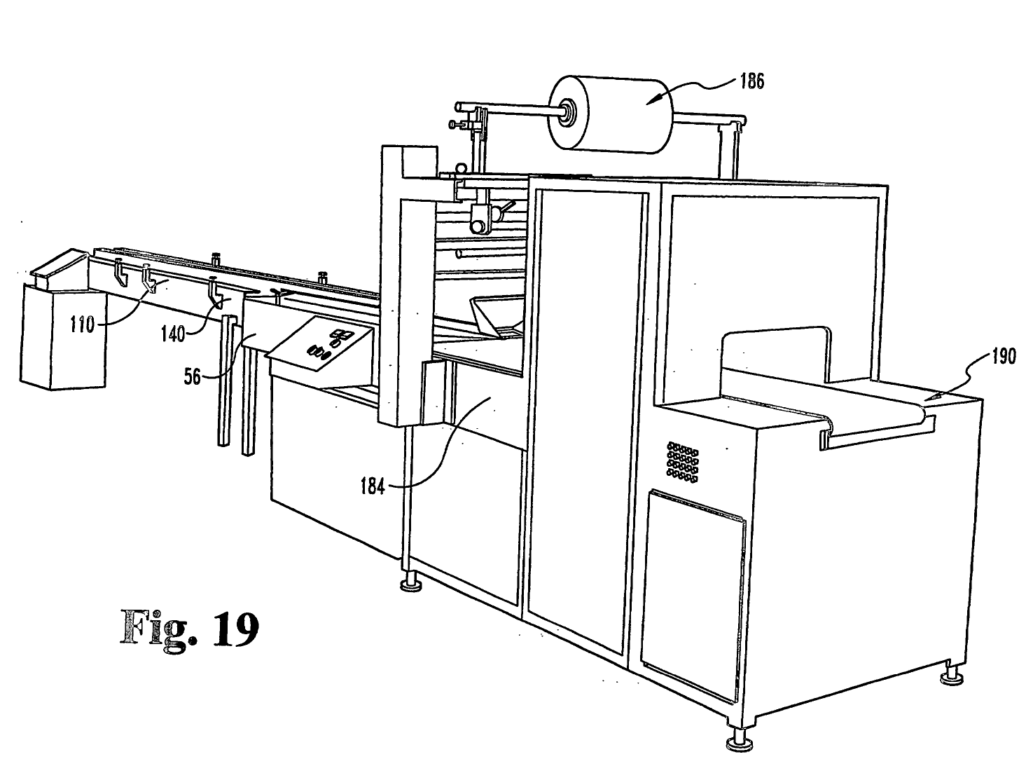

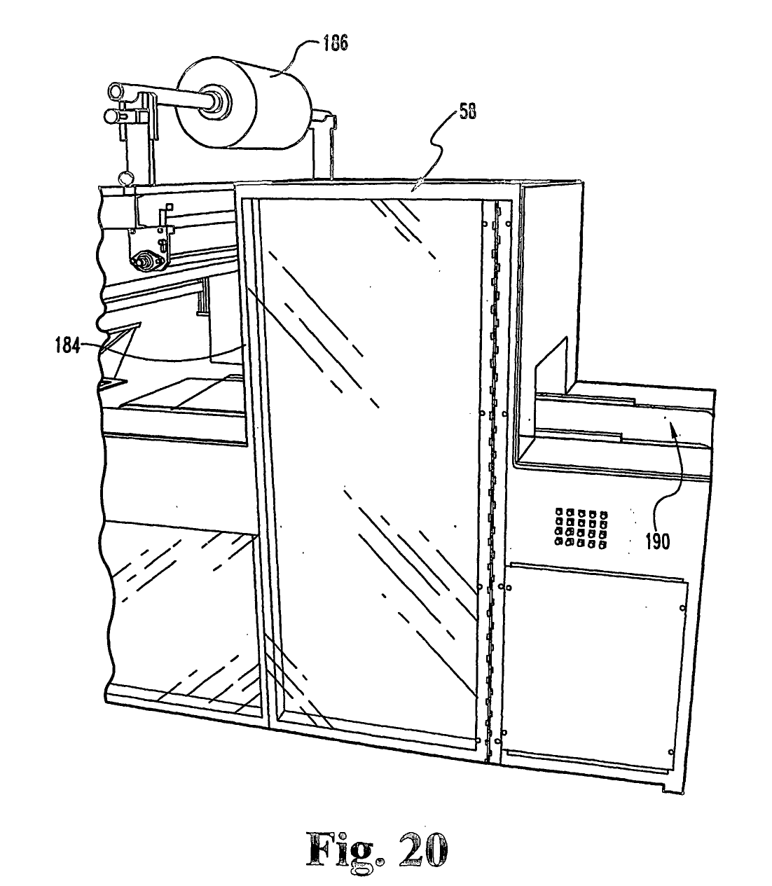

FIGS. 1, 2A, 2B, and 16-20 present various views of a conveyor system 50 which provides products to an infeed section 56 and wrapping and sealing section 58. In one embodiment of the present invention, conveyor system 50 accepts a plurality of products 52 which are spaced apart in a variable, uncontrolled manner. Conveyor system 50 repositions and respaces the products into a predetermined spacing that is compatible with wrapping and sealing section 58. In one embodiment, conveyor system 50 spaces apart the products 52 with equal, repetitive spacing and enables the various mechanisms of wrapping and sealing section 58 to be adjusted for minimum waste of the wrapping material.

In one embodiment of the present invention, wrapping and sealing section 58 includes a supply of heat shrinkable film 186 which is precisely wrapped around the product 52. The precise placement of product 52 minimizes the amount of heat shrinkable film that is used with each package, and thus minimizes the cost of the final product.

Referring to FIGS. 1, 2A, 2B, 3, and 4, a conveying system 50 is shown. Conveyor system 50 transports a plurality of products 52 between a pair of product guides 54. In one embodiment, the products are provided to an infeed section 58, which in turn provides the products to a wrapping and sealing section 58. The present invention contemplates lug-fed, belt-fed, and other types of infeed mechanisms.

Conveyor system 50 preferably includes a plurality of legs 62 which support a pair of opposing siderails 64 and 66 along either side of a conveying path 70. Siderails 64 and 66 include the various driving mechanisms, bushings, bearings, and other components which drive the conveying surface 70 in a direction 71. The top and sides of each siderail 64 and 66 are enclosed within one or more protective covers 68.

In one embodiment of the present invention, conveyor system 50 includes an accumulating section 80, a spacing section 110, and a correction section 140. The operation of spacing 110 and correction section 140 are controlled by an electronic controller 60. In one embodiment, electronic controller 60 uses a combination of digital electronic and analog electronics to perform an algorithm 1000 contained within memory 500.

Accumulating section 80 can be of any type of conveyor. In one embodiment, accumulating section 80 comprises a plurality of roller shafts 84, each of which supports a plurality of shippable rollers 82. Each roller shaft 84 is driven by a sprocket 86 which engages a chain drive 88. An electric motor 90 drives chain 88 through a driving mechanism 91. The products are guided within a funneling section 96 of product guides 54. In one embodiment, accumulating section 80 accepts products 52 in any orientation. Additional information about the driving mechanisms, roller shafts, and slippable rollers can be found in U.S. Pat. Nos. 6,193,047 and 6,516,940, incorporated herein by reference.

Products accumulated on accumulating section 80 are provided to a spacing section 110 which spaces apart the products to an approximate predetermined position. In one embodiment, spacing section 110 includes a plurality of rollers 112 which are coupled in non-slippable fashion to roller shafts 114. Each roller shaft 114 includes a driving sprocket 116 which engages a chain drive 118. An electric motor 120 drives chain 118 through a driving mechanism 121. Although the use of chain drives are shown and described herein, the present invention is also applicable to other driving apparatus, including toothed and non-toothed belts and gear drives.

Products 52 being conveyed along spacing section 110 are provided to a correction section 140 which spaces apart the products to a more precise predetermined position. Correction section 140 preferably includes a plurality of roller shafts 144, each of which supports a plurality of non-slippable rollers 142. Each roller shaft 144 includes a driving sprocket 146 which is adapted and configured for meshing engagement with a chain drive. Each roller shaft 144 preferably includes a sleeve bearing 152 which is captured within a static sleeve support 154 attached to one of siderails 64 or 66. In a preferred embodiment, sleeve support 154 is fabricated from a resilient material. Support 154 includes a plurality of semi-cylindrical notches which are adapted and configured to retain the outer diameter of the sleeve bearings 152. Preferably, the cylindrical indentation is slightly more than one-half of the cylinder, such that the supported sleeve bearing 152 can be snapped in and out of place.

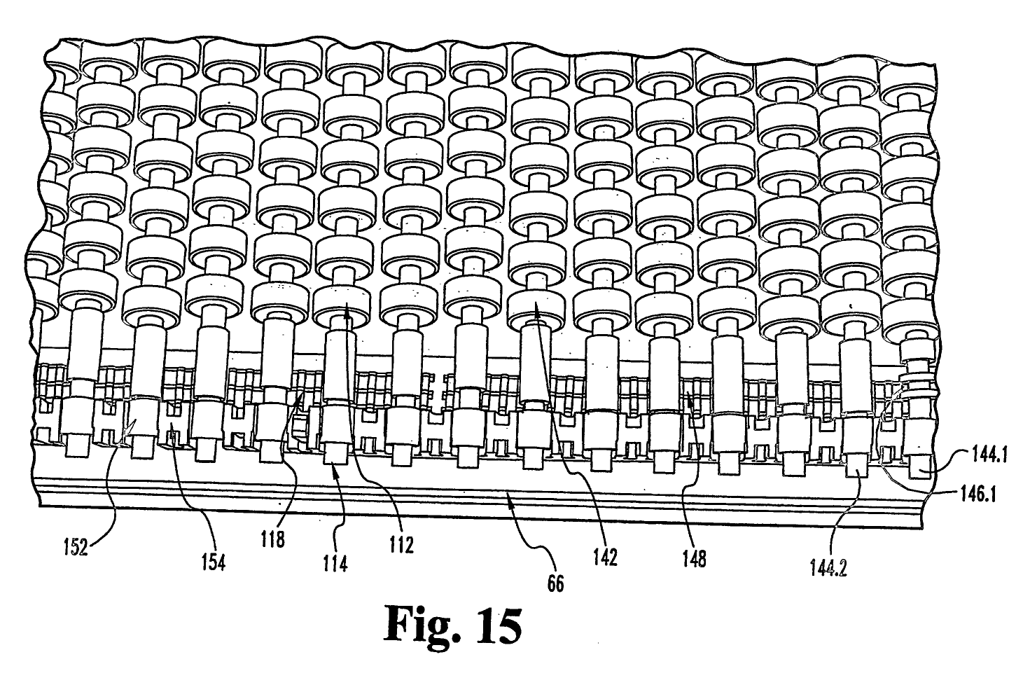

One embodiment of the present invention permits rapid reconfiguration of the length of the product that is being conveyed. Referring to FIG. 15, a roller shaft 144.1 is shown being driven by chain drive 148. Sprocket 146.1 is in meshing engagement with chain 148, and is driven as part of correction section 140. Roller shaft 144.2 is being driven by chain drive 118 (not shown). Sprocket 146.2 (not shown) is in meshing engagement with chain drive 118, and driven as part of spacing section 110.

Shaft 144.2 can be reconfigured quickly so that it is driven as part of correction section 140. After removal of covers 68 from side rails 64 and 66, roller shaft 144.2 can be snapped out of engagement with sleeve supports 154. The loose shaft 144.2 is swapped end for end, and repositioned in the same sleeve support 154, but with the corresponding sprocket 146.2 now in engagement with chain drive 148. Conveyor system 50 thus includes at least one roller shaft that can be driven as part of correction section 140 or spacing section 110.

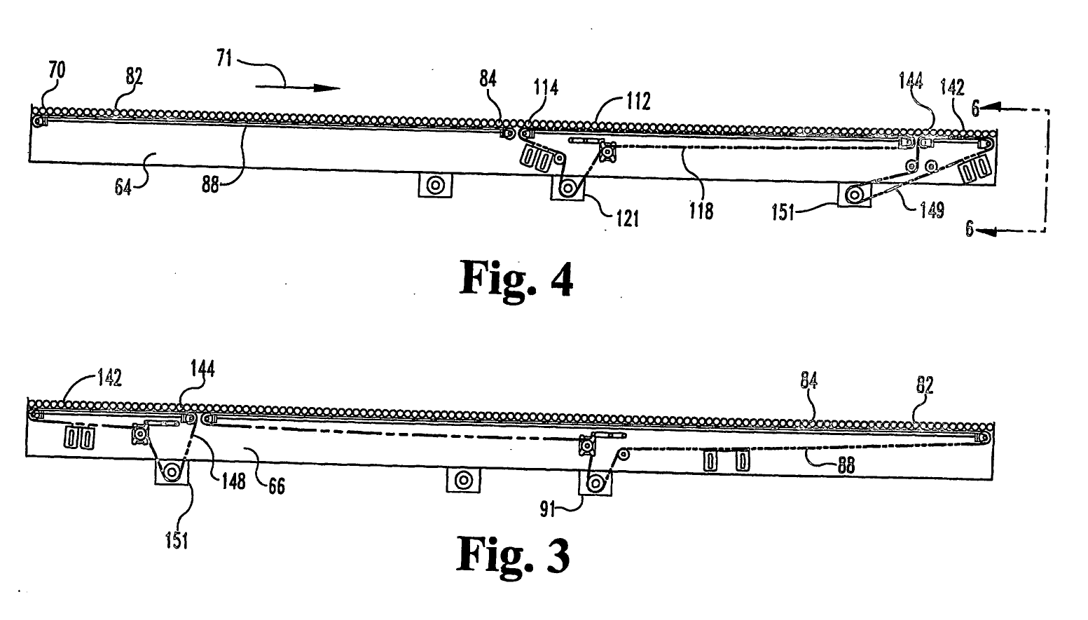

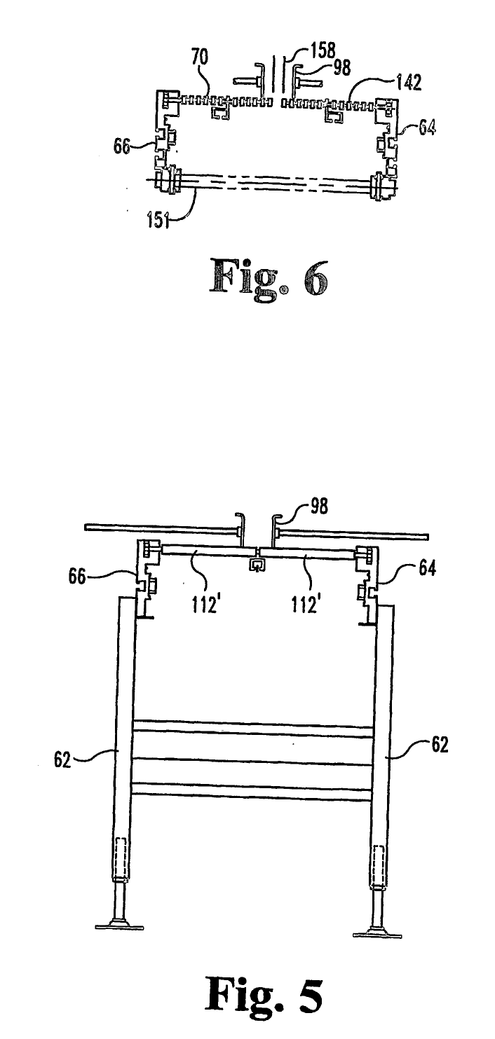

FIGS. 3 and 4 depict the driving relationship between chain 88 and roller shafts 84; and chain 118 and roller shafts are 114. Correction section 140 includes a motor 150 which drives a right-side chain 148 and a left-side chain 149. In a preferred embodiment, chain 149 extends underneath a first set of roller shafts that is less than the set of roller shafts extending over the opposing chain 148. Roller shafts 144 can be driven either from chain 148 or chain 149. As explained above, a portion of roller shafts can be driven by chain 148 or 118, depending upon placement of the sprocket of the particular shaft.

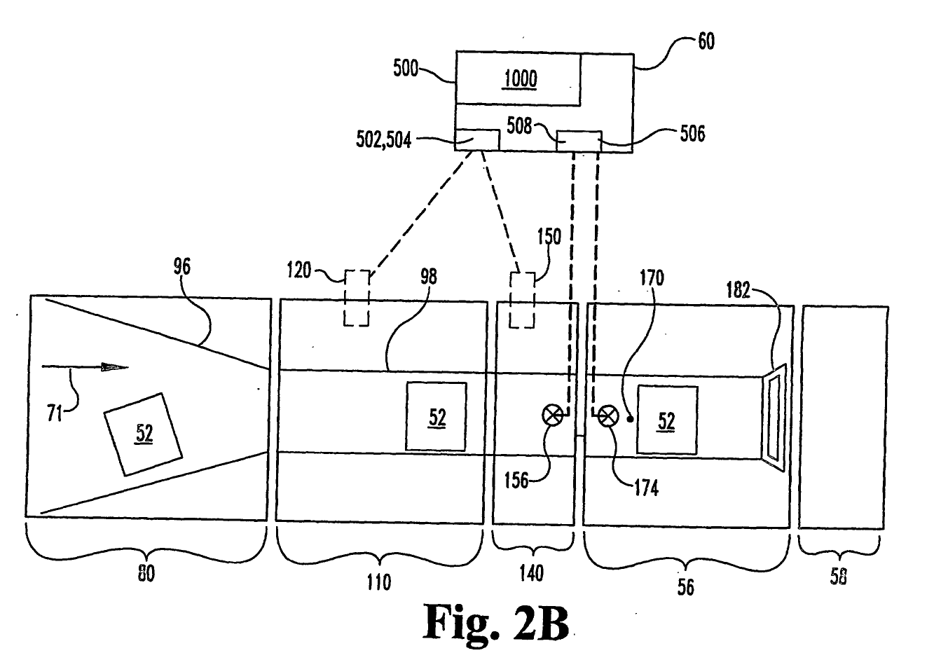

Referring to FIG. 2B, in one embodiment of the present invention, correction section 140 includes a position sensor 156, such as an optical sensor. Position sensor 156 provides a signal which corresponds to the position of a product 52 being conveyed by correction section 140. Infeed section 56 includes another position sensor 174, such as an encoder. In those embodiments in which conveyor system 50 provides products into an infeed section 56, position sensor 174 provides a signal which is interpreted in algorithm 100 to correspond to the spacing between adjacent lugs 170 that are driven by a belt 172 of infeed section 156. Lugs 170 are spaced apart in a predetermined spacing pattern which is adapted and configured to be compatible with the spacing input requirements of wrapping and sealing section 58. In yet other embodiments of the present invention, position sensor 174 provides a position signal which is interpreted in algorithm 100 to correspond to the positional location of a conveying mechanism which feeds product 52 directly into a wrapping and sealing section.

Electronic controller 60 includes analog input provisions 508 and 506, respectively, for receiving signals from sensors 156 and 174. Controller 60 further includes motor controllers 502 and 504, respectively, for control of motors 120 and 150. Controller 60 includes memory 500 which stores software 1000. In other embodiments of the present invention, electronic controller 60 also receives an input from interfacing devices such as a keyboard or mouse, and also provides output to a video display terminal, for input and output, respectively, with a human operator.

Controller 60 controls the conveying speed of both spacing section 110 and correction section 140. In one embodiment, motor 120 is a variable frequency drive motor which provides a velocity of 300 feet per minutes at 60 hertz. Motor 150 is an MGM-350 servo motor which provides a velocity of 500 fee per minute at 3000 rpm.

Controller 60 adjusts the speed of spacing section 110 so as to provide products 52 in approximately the desired predetermined spacing. These approximately-spaced products are provided onto correction section 140, on which there is further correction of the location of a particular product, so that that particular product is provided to a corresponding position of a lug 170 on infeed section 56. In other embodiments of the present invention, correction section 140 corrects the approximate positions of the products 152 such that each product exits correction section 140 with a predetermined spacing compatible with wrapping and sealing section 58. Controller 60 is capable of precisely spacing the flow of products to either “hardware” lugs or to a “virtual” position.

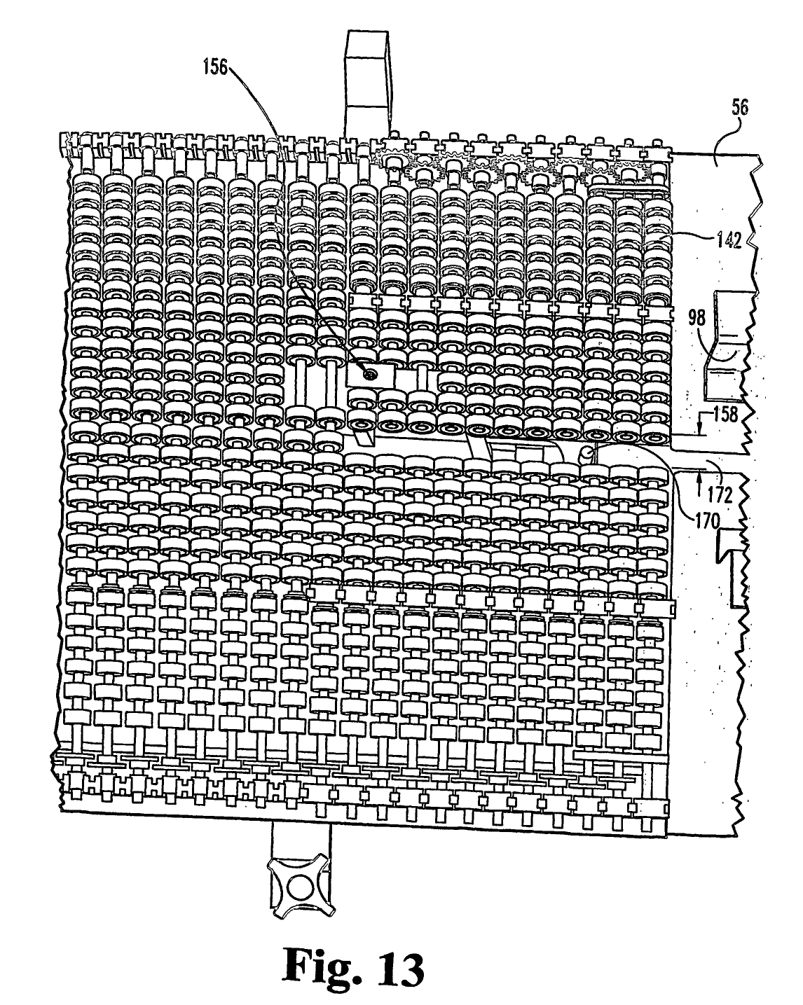

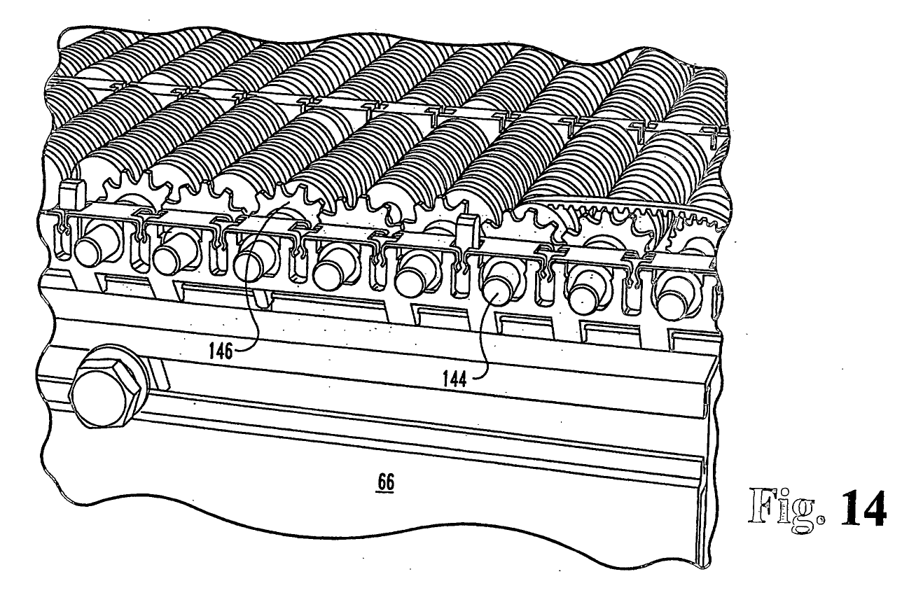

As one example, if the products 52 are too closely spaced along spacing section 110, controller 60 will compensate for this error by slowing down the speed of rollers 112. Likewise, if controller 60 senses by way of position sensor 156 that products 52 are spaced too far apart, a signal will be sent to motor 120 to speed up the flow of products along spacing section 110. Further, controller 60 adjusts the speed of rollers 142 in correction section 140 by adjusting the signal sent to servo motor 150. As best seen in FIG. 13, one embodiment of correction section 140 incorporates a gap 158 between rollers 142 to accommodate the moving lugs 170.

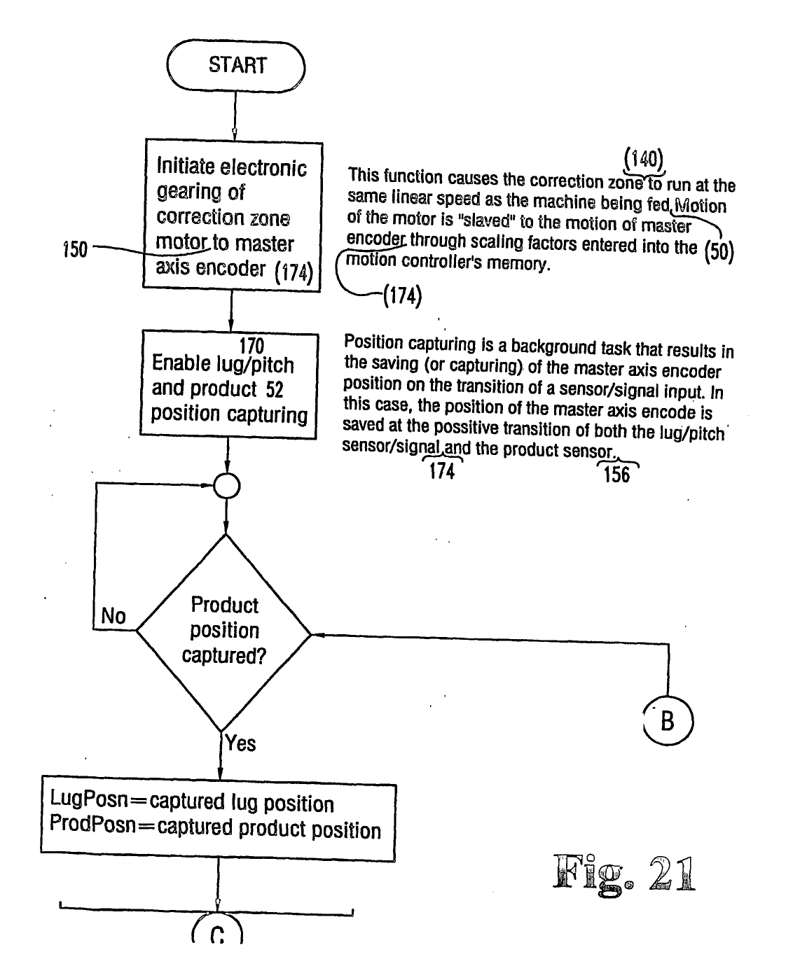

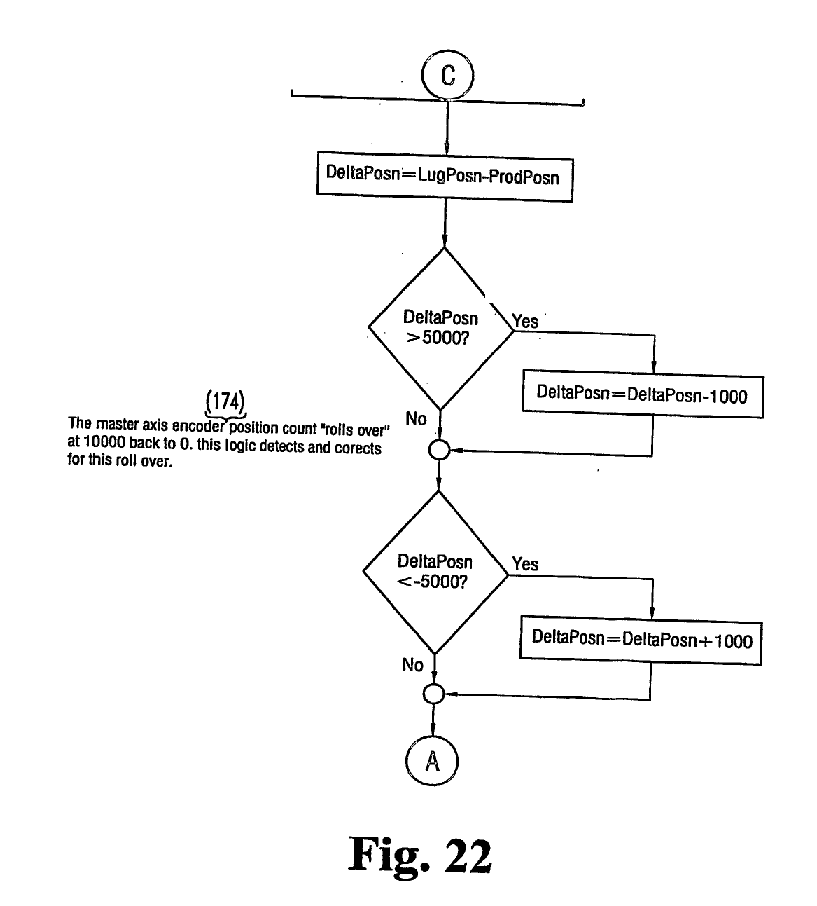

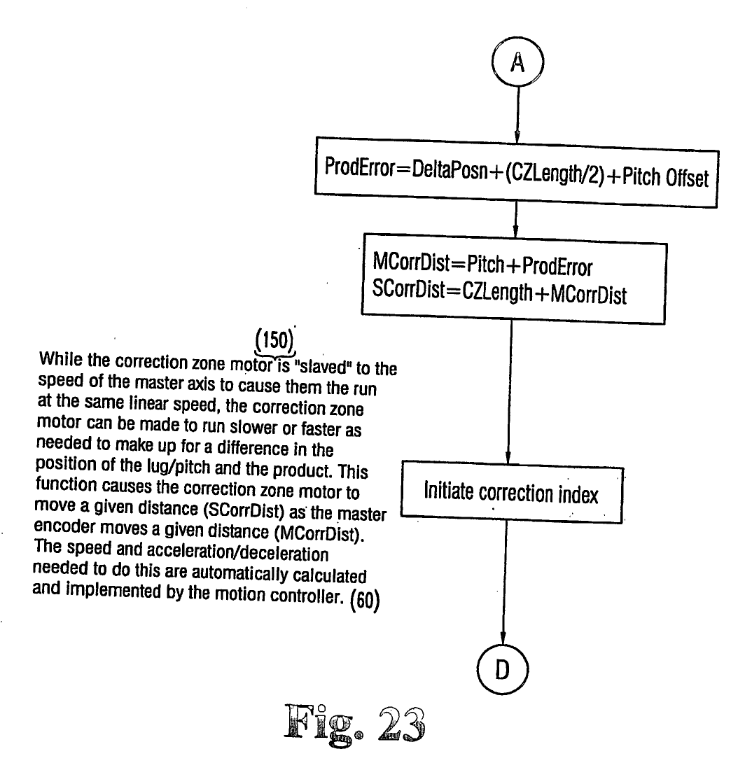

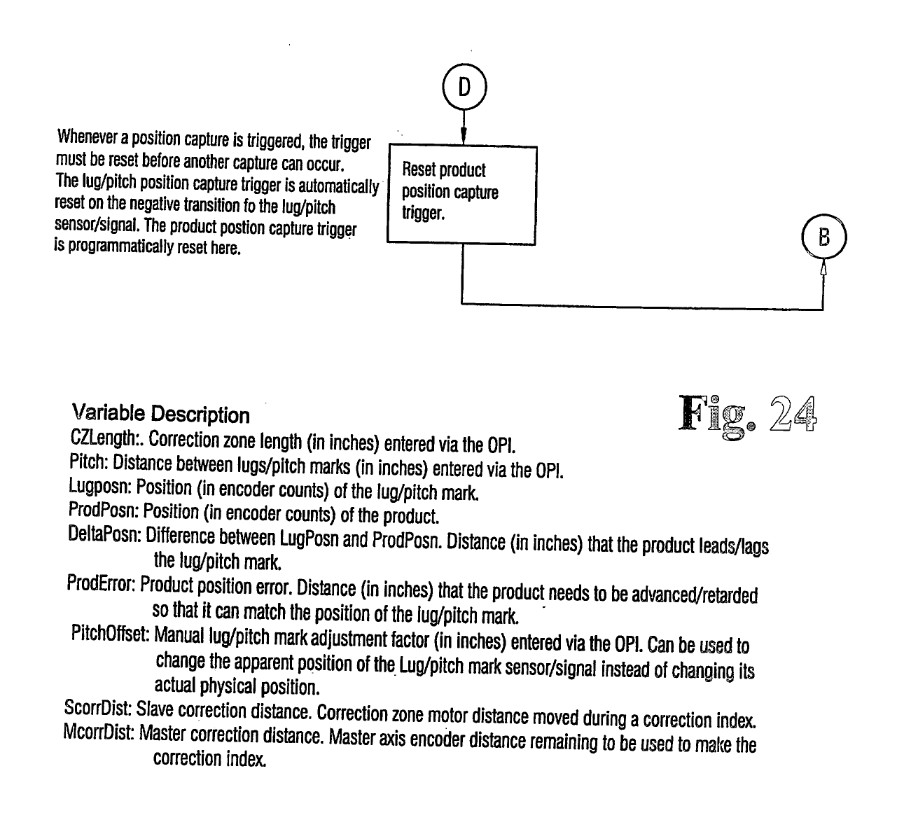

One embodiment of software 1000 is shown diagrammed in a flowchart in FIGS. 21-24.

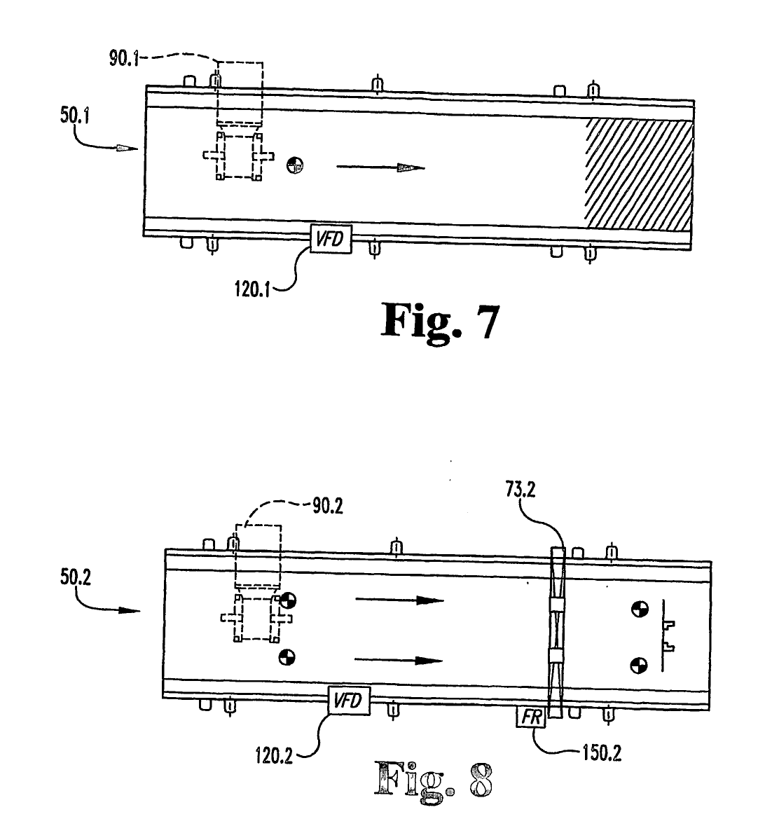

FIGS. 7-10 depict alternate embodiments of the present invention. The use of decimal notation with an element number (XXX.1) refers to an element that is the same as the non-notated number (XXX), except for the differences that are shown or described.

FIG. 7 shows a conveying apparatus 50.1 having a motor 90.1 to drive an accumulation section 80.1 and a motor 120.1 to drive a spacing section 110.1. Products are provided directly to an infeed section 56.1.

FIG. 8 shows a conveying apparatus 50.2 having a motor 90.2 to drive an accumulation section 80.2 and a motor 120.2 to drive a spacing section 110.2. A correction section 140.2 driven by motor 150.2 provides products to an infeed section 56.2. An overhead brake 73.2 positions products being conveyed.

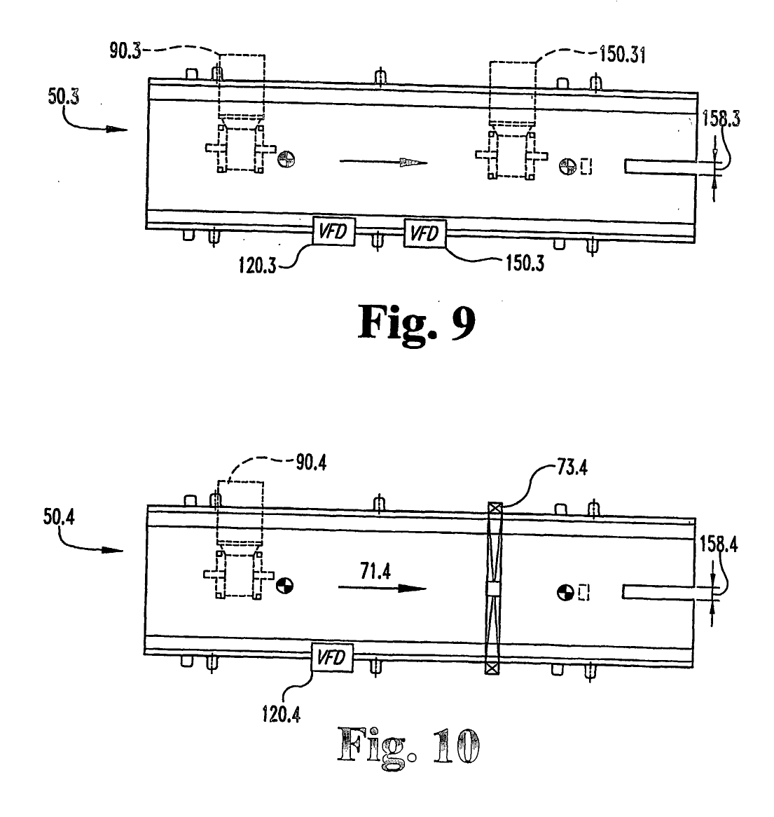

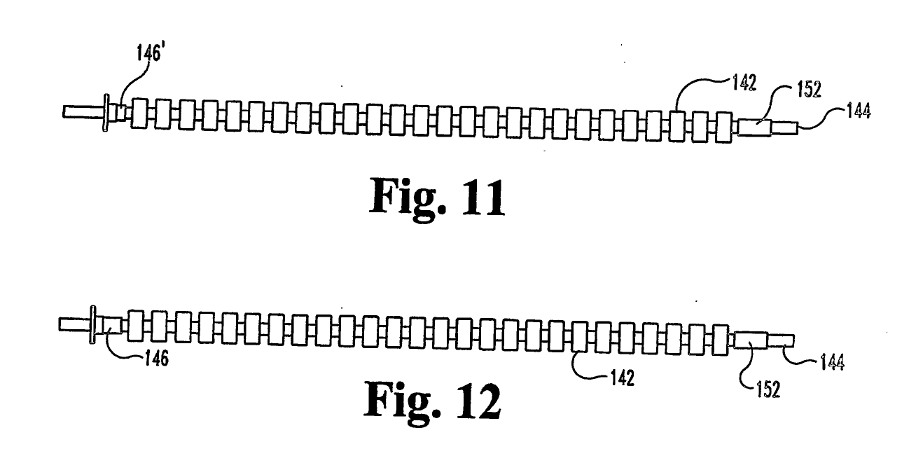

FIG. 9 shows a conveying apparatus 50.3 having a motor 90.3 to drive an accumulation section 80.3 and a motor 120.3 to drive a spacing section 110.3. A correction section 140.3 driven by motor 150.3 provides products to a slippable roller conveyor section driven by a motor 150.31 that is similar to motor 90.3. Products are provided to an infeed section 56.3.

In some embodiments, apparatus 50.3 further includes a first slippable roller section 1080.3, a second shippable roller section 1080.3′, followed by a positive drive section 1150.3. A product stop 1600 separates zone 1080.3′ from zone 1150.3. The slippable rollers of section 1080.3 are adapted and configured to slip at a first predetermined torque. The slippable rollers of section 1080.3′ are adapted and configured to slip at a second predetermined torque that is greater than the first predetermined torque. Therefore, the slippable rollers of section 1080.3′ are less slippable than the slippable rollers upstream, but more shippable than the positive drive rollers that are downstream. This increase in the slippable torque can be accomplished by a number of methods known to those of ordinary skill in the art, including the use of springs which spring load the slippable rollers on their roller shafts.

As products are conveyed along conveyor 50.3, they are stopped by product stop 1600, the actuation of which is controlled by controller 1060. As controller 1060 senses the position of the next infeeding opportunity, product stop 1600 is lowered. Since it is located on roller shafts whose rollers are adapted and configured for less slippage and higher torque, the next product fed to the infeed accelerates more quickly along the conveying path than the product immediately behind it. This increased acceleration allows for a gap between these two products, and this gap permits controller 1060 to raise product stop 1600 for the next cycle. Preferably, the conveying length of section 1080.3′ is less than the length of the product, but more than about 40 percent of the length of the product. Most preferably, the length of conveying section 1080.3′ is between 50 to 75 percent of the length of the product.

FIG. 10 shows a conveying apparatus 50.4 having a motor 90.4 to drive an accumulation section 80.4 and a motor 120.4 to drive a spacing section 110.4. Products are provided directly to an infeed section 56.4. An overhead brake 73.4 positions products being conveyed.

Although some embodiments of the present invention have been shown and described using heat shrinkable film to wrap the product, the invention is not so limited. The present invention contemplates the use of any type of product packaging. Further, conveying system 50 can provide spaced apart products to any type of equipment that require a predetermined spacing between products. Further, the present invention does not require feeding of the spaced apart products to an infeed section with lugs. Conveying system 50 can supply spaced apart products directly to the equipment requiring the spaced apart product.

The present invention relates to various apparatus and methods for accurately spacing a plurality of products by a conveyor, which is preferably a roller conveyor. However, some embodiments of the present invention also pertain to belted conveyors. Although reference is made to conveyors where the roller shafts each support a plurality of rollers, the present invention also contemplates those embodiments in which a roller shaft supports a single roller spanning the width of the conveying surface.

Some embodiments of the present invention accumulate and space apart the products which are presented to wrapping machines. In some embodiments, these wrapping machines have belted or flighted infeeds to their machines. Such wrappers are made by manufacturers such as Shanklin, Kallfass, SIG Doboy, Conflex, Hugo Beck, and Arpac. In particular, some embodiments of the present invention are compatible with high speed wrapping machines such as the Texwrap 1809, the SIG Doboy Linium, the Shanklin HS series, the Arpac Capra, the Hugo Beck 400 or 500 series, and the Kallfass ServoJet machine. However, the present invention is adaptable to any kind of wrapping and infeed system. Further, some embodiments of the present invention provide products to machines other than wrapping machines.

One embodiment of the present invention relates to multiple conveying sections which pass products from one section to the other. The first section includes an accumulating conveyor, such as a slippable roller conveyor. A funneling chute placed over the conveying surface directs the products to a prescribed area of the conveying path. The accumulated products are preferably guided through this prescribed area onto a second conveying section. This second conveying section, in one embodiment, is a positive drive, non-slippable conveyor.

For those embodiments in which the speed of the second conveying section is less than the speed of the first conveying section, the accumulated products gather on the second section in back to back, or touching, manner. Shingling of the products (where one product is driven to ride over a downstream product) can be avoided by limiting the pressure of upstream products on the accumulating section. In some embodiments, this limitation in the accumulating pressure is provided by slippage of the rollers of the first section. In other embodiments, a brake can be applied to the first section, or power can be removed from the first section.

In some embodiments, the back to back products of the second section are received by a third, downstream conveying section, this third section preferably including positive drive rollers. This third section is generally controlled at substantially the same speed as the second section. However, the third section can be accelerated or decelerated to convey products to a downstream conveyor in an accurate predetermined pattern. Typically, the predetermined pattern is repetitive spacing, but the present invention also contemplates those embodiments in which products are provided downstream with variable spacing.

In a preferred embodiment, the operation of the third section, and preferably the operation of the second section, corresponds to a positional signal received from the downstream conveyor. In one embodiment, the downstream conveyor is a lugged infeed conveyor, where the lugs are spaced apart in a predetermined manner. A positional signal indicating the current position of the lugs is provided to an electronic controller, which controls operation of the third section so as to provide the downstream-most product to a position in between adjacent lugs. In some embodiments, the controller places the product close to either the forward lug, whichever is desired by the operator. For example, in some embodiments, it is desirable to place the product near the rearward lug, so that the acceleration of the product onto the downstream infeed conveyor is smooth and not disruptive to the product.

Yet another embodiment of the present invention includes a section of a conveyor in which a first driving element, such as a chain, is driven in a first manner. The conveyor includes a second driving element, such as a second chain, which is driven in a second manner. Some embodiments further include a roller shaft having a single driving wheel which can be engaged with either the first driving element or the second driving element. Preferably, the first driving chain is placed along a first side of the conveying place and the second driving element is placed on the opposite side of the conveying path. In those embodiments, a roller shaft driven by one driving element can be snapped out of place from its holders, swapped end for end, and reinserted into the same holders (at the same longitudinal location), yet be driven by the other driving element. In yet other embodiments, the first driving element and the second driving element are on the same side of the conveyor, in which case the roller shaft is removed from its location, indexed laterally to engage the other driving element, and reinstalled onto the conveyor structure.

A driving chain can be of any type and any material that can drive a toothed, ribbed, or geared wheel, including as examples chain links and ribbed belts, and their equivalents. Most generally, one of the chain or the wheel includes a plurality of male features, and the other of the chain or wheel includes a plurality of female features, such that the male and female features periodically interengage to transmit a load therebetween and disengage when not transmitting a load. One example is a metallic or plastic chain driving a sprocket. Another example is a toothed belt driving a slotted wheel.

A driving member includes any means for driving roller shafts of a conveyor, including a driving chain such as the chains used for driving a sprocket, and also including drive shaft such as the drive shafts used for driving elastomeric belts which drive roller shafts, and their equivalents.

Means for driving a driving chain or driving member includes any type of electric, hydraulic, and pneumatic motors, including AC motors, DC motors, and servo motors, and their equivalents.

The moving conveying surface of the infeed conveyor can be of any type, including for example belt conveyors and lugged conveyors, and their equivalents.

Means for stopping a products includes a product stop which blocks the conveying path in front of the product, such as that described in U.S. Pat. No. 6,098,786; product brakes which restrain the product by pressing on the product from above; product brakes which stop the product by pressing on the slippable rollers from below; and their equivalents.

A conveyor refers to a whole conveyor or a portion of a conveyor. Likewise, a conveying section refers to a whole conveyor or a portion of a conveyor. In some embodiments, the conveying surface is spanned from side to side by a single driving element or roller. In other embodiments, the conveying surface is spanned by a plurality of driving elements or rollers.

The conveying speed of a section of a conveyor is the linear speed at which that section of the conveyor propels the product along the conveying path. The conveying speed corresponds to the product of the rotational speed of the roller and the diameter of the roller. Substantially equivalent conveying speeds can be obtained by increasing one of the rotational speed or roller diameter and decreasing the other.

A roller is fixed to a corresponding roller shaft by any means known in the art, including press fit, keyed fit, compressive fit between opposing shoulder, and their equivalents. A roller is slippable about a corresponding roller shaft by any means known in the art, including the methods described in U.S. Pat. No. 3,951,255, incorporated herein by reference, and also the methods described in the other patents and applications included herein by reference.

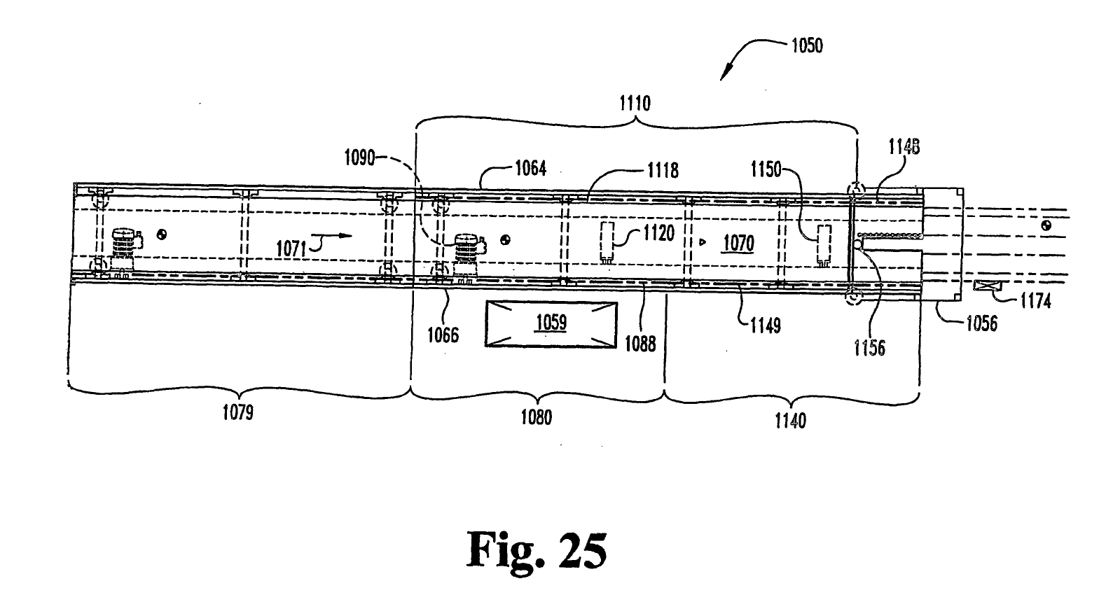

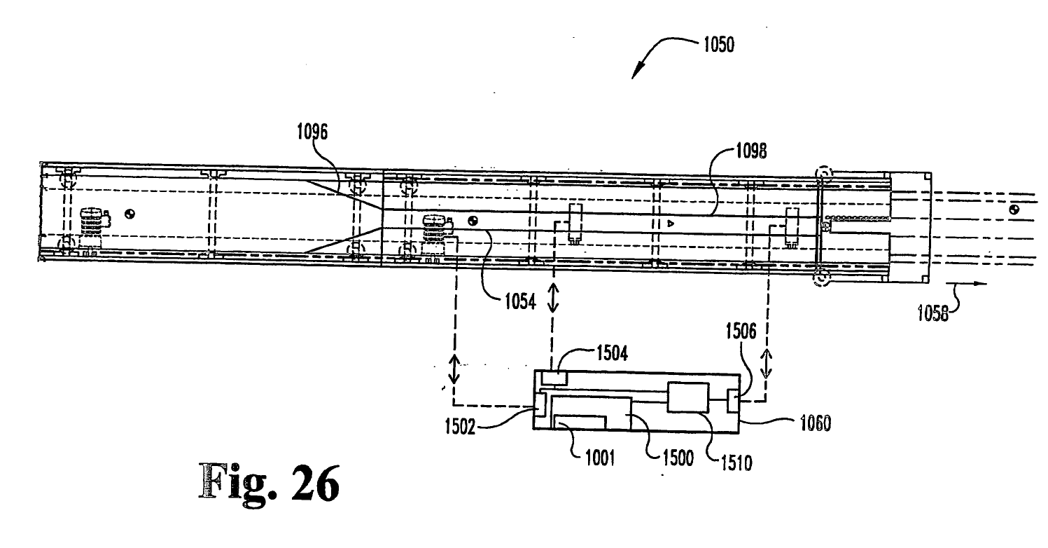

FIGS. 25 and 26 present various views of a conveyor system 1050 according to another embodiment of the present invention which provides products to an infeed section 1056 and wrapping and sealing section 1058. The use of a 1000 prefix (1xxx) denotes an element that is the same as the non-prefixed element number (xxx), except for the differences that are shown or described hereafter.

In one embodiment of the present invention, conveyor system 1050 accepts a plurality of products 52 from an upstream supply conveyor 1079 which are spaced apart in a variable, uncontrolled manner. Conveyor system 1050 repositions and respaces the products into a predetermined spacing that is compatible with wrapping and sealing section 1058. In one embodiment, conveyor system 1050 spaces apart the products 52 with equal, repetitive spacing and enables the various mechanisms of wrapping, infeeding, and sealing section 58 (not shown) to be adjusted for minimum waste of the wrapping material and minimum disturbance or damage to the product.

In one embodiment of the present invention, wrapping and sealing section 1058 includes a supply of heat shrinkable film 1186 which is precisely wrapped around the product 52. The precise placement of product 52 minimizes the amount of heat shrinkable film that is used with each package, and thus minimizes the cost of the final product.

Conveyor system 1050 transports a plurality of products 52 between a pair of product guides 1054. In one embodiment, the products are provided to an infeed section 58, which in turn provides the products to a wrapping and sealing section 58. The present invention contemplates lug-fed, belt-fed, and other types of infeed mechanisms, and their equivalents.

Conveyor system 1050 preferably includes a plurality of legs 1062 which support a pair of opposing siderails 1064 and 1066 along either side of a conveying path 1070. Siderails 1064 and 1066 include the various driving mechanisms, bushings, bearings, and other components which drive the conveying surface 1070 in a direction 1071. The top and sides of each siderail 1064 and 1066 are preferably enclosed within one or more protective covers 1068.

In one embodiment of the present invention, conveyor system 50 includes an accumulating section 1080, a spacing section 1110, and a correction section 1140. The operation of spacing 1110 and correction section 1140 are controlled by an electronic controller 1060 enclosed in a housing 1059. In one embodiment, electronic controller 60 uses a combination of digital electronic and analog electronics to perform an algorithm 1001 contained within memory 1500. Electronic controller 1060 is operatively connected to motors 1090, 1120, and 1150. In a preferred embodiment, each of these motors is an electric motor, and controller 1060 includes the appropriate motor controllers 1502, 1504, and 1506 which interface with motors 1090, 1120, and 1150, respectively. Through these interfaces, motor feedback is provided to controller 1060. For motors 1120 and 1150, this feedback includes the position of the motor. Each motor controller is in electrical communication with a main control unit 1510, which in some embodiments is a digital controller. However, the present invention also contemplates the use of an analog controller.

Accumulating section 1080 can be of any type of conveyor. In one embodiment, accumulating section 1080 comprises a plurality of roller shafts 1084, each of which supports a plurality of slippable rollers 1082. Each roller shaft 1084 is driven by a sprocket 1086 which engages a chain drive 1088. An electric motor 1090 such as a variable frequency drive drives chain 1088 through a driving mechanism 1091. One example of a motor 1090 is a 22A-A2P3N104 Flex 4 VFD manufactured by Allen Bradley. The products are guided within a funneling section 1096 of product guides 1054. In one embodiment, accumulating section 1080 accepts products 1052 in any orientation. Additional information about the driving mechanisms, roller shafts, and shippable rollers can be found in U.S. Pat. Nos. 6,193,047 and 6,516,940, incorporated herein by reference.

Referring to FIG. 25, one embodiment of the present invention includes conveying zones 1080, 1110, and 1140, which can be easily reconfigured into different lengths. Conveying section 1080 includes a chain drive 1088 (also shown as D3) which is powered by motor 1090, the chain extending for a length of about one and one-half meters along the left side of flow path 1070. Proximate to chain 1088 on the left side of flow path 1070 is chain drive 1149 which is powered by motor 1150. On the opposite of conveying path 1070, and overlapping at least a portion of chain drives 1088 and 1149, is chain drive 1118 which is powered by motor 1120. Still referring to FIG. 25, zone 1110 can extend anywhere along the length of chain 1118. Zone 1080 can extend anywhere along the length of chain 1088. Zone 1140 can extend anywhere along the length of chain 1149. Chains 1088, 1118, and 1150 are each operated to convey products in direction 1071.

In one embodiment of the present invention, the length of a specific zone or section 1080, 1110, or 1140 is established by the orientation of the drive sprocket for the corresponding roller shaft. In a preferred embodiment, a roller shaft 1164 populated with a plurality of slippable rollers 1162 and having a single drive sprocket 1166 on one end is mounted in side rail 1066 such that sprocket 1166 engages chain 1088. In that preferred embodiment, a roller shaft 1144 having a plurality of non-slippable, fixed rollers 1142 is mounted to the conveyor side walls such that sprocket 1146 drivingly engages chain 1064. A plurality of roller shafts 1144 are also mounted to the side rails 1064 and 1066 such that the corresponding sprockets 1146 are drivingly engaged with chain 1149. With this arrangement, the length of conveying section 1140 is established by the number of adjacent roller shafts having sprockets engaging chain 1149. The length of zone 1110 is established by the plurality of adjacent roller shafts 1144 whose sprockets engage chain 1118 upstream of zone 1140. The length of zone 1080 is established by the adjacent roller shafts 1164 whose sprockets engage chain 1088 immediately upstream of zone 1110. The length of any of these zones can be easily altered by simply removing a roller shaft at the zone-to-zone interface, and turning it over, end for end, so that the sprocket is placed on the opposite side of the conveyor, and engages the chain on the opposite side of the conveyor. Although the use of fixed rollers in zones 1140 and 1110 have been shown and described, the present invention contemplates the use of any type of roller in any of the zones 1080, 1110, and 1140, including a single roller on the shaft.

Products accumulated on accumulating section 1080 are provided to an accumulation zone 1110 which receives the products and preferably maintains the products touching one another with little or no gap between products. In one embodiment of the present invention, accumulating section 1080 is operated at a conveying speed which is greater than the conveying speed of zone 1110. Therefore, products are offered to zone 1110 faster than the rate at which they are removed from zone 1110. The excess products which cannot be accommodated in zone 1110 accumulate on section 1080, and can further backup onto upstream conveying section 1079. Preferably, accumulating section 1080 and upstream conveying section 1079 use slippable rollers or some other means (including stopping the rotation of the appropriate rollers by removal of power or use of a brake) so as to minimize or eliminate damage to the stopped, motionless product.

In one embodiment, spacing section 1110 includes a plurality of rollers 1112 which are coupled in non-slippable fashion to roller shafts 1114. Each roller shaft 1114 includes a driving sprocket 1116 which engages a chain drive 1118. An electric motor 1120 such as a variable frequency AC motor drives chain 1118 through a driving mechanism 1121. Although the use of chain drives are shown and described herein, the present invention is also applicable to other driving apparatus, including toothed and non-toothed belts and gear drives. Further, the present invention contemplates the use of any type of motor.

Products 52 being conveyed along spacing section 1110 are provided to a spacing section 140 which spaces apart the products with a spacing appropriate for the spacing requirements of the downstream infeed conveyor 1056. Correction section 1140 preferably includes a plurality of roller shafts 1144, each of which supports a plurality of non-slippable rollers 1142. Each roller shaft 1144 includes a driving sprocket 1146 which is adapted and configured for meshing engagement with a chain drive. Each roller shaft 1144 preferably includes a sleeve bearing 1152 which is captured within a static sleeve support 1154 attached to one of siderails 1064 or 1066. In a preferred embodiment, sleeve support 1154 is fabricated from a resilient material. Support 1154 includes a plurality of semicylindrical notches which are adapted and configured to retain the outer diameter of the sleeve bearings 1152. Preferably, the cylindrical indentation is slightly more than one-half of the cylinder, such that the supported sleeve bearing 1152 can be snapped in and out of place.

In one embodiment, the roller shafts of zone 1110 and zone 1140 are “electronically geared” together. Electronic controller 1060 provides this electronic gearing. Controller 1060 receives positional feedback from the respective motors 1120 and 1150, and operates them such that they operate at substantially the same speed and at times operate in phase (i.e., with a fixed positional relationship between the motors and between the respective driving members). Examples of motor 1120 and 1150 include 2098-DSD-202 Utra 3000 Servo Drive and MPL-A310F-HJ22AA Servo Motor, both manufactured by Allen Bradley. However, controller 1060 alters its driving signals to the third group as required so as to change the spacing of products being provided to infeed conveyor 1056. Conveyors 1110 and 1140 operate at substantially the same conveying speed for the plurality of products extending over these two zones. As mentioned previously, these products are substantially touching, with minimal or no gap between products. Preferably, the products are touching.

Controller 1060 alters the speed of chain 1149 in order to place a product at the proper location on infeed conveyor 1056. One example of a controller 1060 is a DMC-2123-DINDC24 2 Axis Motion Control Card manufactured by Galil. Typically, infeed conveyor 1056 includes a plurality of spaced apart lugs or other surface or physical indicia which establishes the positional boundaries for a product being conveyed to these wrapping machine. For example, a lugged infeed conveyor may have a spacing of 8 inches between adjacent lugs in order to accept a product that has a length less than 8 inches. Infeed conveyor 1056 preferably includes a sensor 1174 such as an encoder that sends a signal to controller 1060 which corresponds to the position of the lugs. Further, conveying section 1140 includes a positional sensor 1156 (such as a photocell) which sends a signal to controller 1060 which corresponds to the presence or absence of a product proximate to sensor.

Controller 1060 operates zones 1110 and 1140 so as to produce a plurality of back-to-back products upstream of sensor 1156. As the next product is detected by sensor 1156 and sensor 1174 provides the position of the next lug, controller 1060 alters its drive of zone 1140 so as to place the product at the predetermined location between lugs of infeed conveyor 1056. In some situations, controller 1060 will speed up conveying section 1140 relative to section 1110. In other situations, controller 1060 will slow down conveyor 1140 relative to conveyor 1110. This slow down can include a temporary slowing of conveyor 1140 or temporary stoppage of conveyor 1140.

In some embodiments, controller 1060 places the product between adjacent lugs of the infeed conveyor. Therefore, a 6 inch product would be placed 1 inch from the first lug where the lugs are 8 inches apart. However, in some applications it is preferable to place the product immediately next to a lug. In some embodiments, controller 1060 uses signals from sensors 1156 and 1174 so as to place the product immediately after a lug, and in other applications uses these signals to operate conveyor 1140 to place the product immediately in front of a lug. This latter placement is especially useful in those situation where the product is placed onto a platform of infeed conveyor 1056, and the lug comes up from the bottom of conveyor 1056 through a slot in the platform, and pushes the product sitting on the platform. In this situation, the product may be temporarily motionless sitting on the platform prior to being pushed by the lug. By placing the product as close as possible to the rear of the available spacing, the acceleration forces from the lug onto the product are minimized. This is especially useful for products that easily tip over, or which contain a spillable product.

While the invention has been illustrated and described in detail in the drawings and foregoing description, the same is to be considered as illustrative and not restrictive in character, it being understood that only the preferred embodiment as been shown and described and that all changes and modifications that come within the spirit of the invention are desired to be protected.

What is claimed is:

1. A method for conveying products to a downstream conveyor, comprising:
providing a first conveyor having a plurality of roller shafts, each roller shaft driving at least one roller;
driving a first group of rollers shafts at a first speed;
driving a second group of roller shafts at a second speed, the second speed being less than the first speed, the second group being downstream of and proximate to the first group;
driving a third group of roller shafts at substantially the second speed, the third group being downstream of and proximate to the second group; and
altering said driving of the third group relative to said driving of the second group so as to change the spacing between adjacent products being provided to the downstream conveyor.

2. The method of claim 1 wherein said altering includes spacing adjacent products to a predetermined spacing.

3. The method of claim 2 wherein the predetermined spacing corresponds to the distance between product driving lugs of the downstream conveyor.

4. The method of claim 1 which further comprises providing a first driving motor for driving the first group, a second driving motor for driving the second group, and a third driving motor for driving the third group.

5. The method of claim 4 wherein the second motor is a servo motor and the third motor is a servo motor.

6. The method of claim 5 wherein the first motor is a variable frequency motor.

7. The method of claim 1 wherein each roller shaft of each group drives a plurality of rollers.

8. The method of claim 1 wherein each roller shaft of the first group drives a plurality of slippable rollers.

9. The method of claim 8 wherein each roller shaft of the second group drives a plurality of rollers which are fixed to the corresponding shaft.

10. The method of claim 8 wherein each roller shaft of the third group drives a plurality of rollers which are fixed to the corresponding shaft.

11. The method of claim 1 wherein the first speed, second speed, and third speed refer to the rotational speed of the corresponding group of roller shafts.

12. The method of claim 1 wherein the first speed, second speed, and third speed refer to the conveying path speed of the at least one roller supported by the corresponding group of roller shafts.

13. A conveyor for conveying products along a conveying path, comprising:
a first support member extending along one side of the conveying path and parallel to the conveying path;
a second support member extending along the opposite side of the conveying path and parallel to the conveying path;
a first driving member supported by said first support member and extending along a first length of said first support member, said first driving member driving at least a first roller;
a second driving member supported by said second support member and extending along a second length of said second support member, said second driving member driving at least a second roller;
a third driving member supported by said first support member and extending along a third length of said first support member, said third driving member driving at a third roller, wherein the second length overlaps a portion of the first length and the second length overlaps a portion of the third length;
a first means for driving said first driving member;
a second means for driving said second driving member; and
a third means for driving said third driving member.

14. The conveyor of claim 13 wherein said first driving member drives a plurality of slippable rollers.

15. The conveyor of claim 14 wherein said second driving member drives a plurality of fixed rollers.

16. The conveyor of claim 15 wherein said third driving member drives a plurality of fixed rollers.

17. The conveyor of claim 13 which further comprises an electronic controller operatively coupled to said first driving means, said second driving means, and said third driving means.

18. The conveyor of claim 17 wherein said controller operates said second driving member and said third driving member at substantially the same speed.

19. The conveyor of claim 17 wherein said controller alters the position of said second driving member and relative to the position of said third driving member.

20. The conveyor of claim 13 wherein said first driving member is a first driving chain, said second driving member is a second driving chain, and said third driving member is a third driving chain.

21. The conveyor of claim 13 wherein said second driving means is a first servo motor, and said third driving means is a second servo motor.

22. A conveyor for conveying a product comprising:
a first driving chain placed along a side of a conveying path and parallel to the conveying path, said first chain being driven in a first manner;
a second driving chain placed along a side of the conveying path and parallel to the conveying path, at least a portion of the length of said second driving chain overlapping at least a portion of said first driving chain, second chain being driven in a second manner different than the first manner; and
a roller shaft having two ends and a driving wheel proximate to one end of said shaft; and
at lease one roller driven by said shaft, said at least one roller being adapted and configured for conveying the product;
wherein said conveyor is adapted and configured to rotatably support said roller shaft such that said driving wheel is capable of engaging said first chain and driving said roller shaft in the first manner, and said conveyor is adapted and configured to rotatably support said roller shaft such that said driving wheel is capable of engaging said second chain and driving said roller shaft in the second manner.

23. The conveyor of claim 22 which further comprises an electronic controller operatively coupled to said first chain to drive said first chain in the first manner and operatively coupled to said second chain to drive said second chain in the second manner, a first sensor providing a first signal corresponding to the position of said first chain, and a second sensor providing a second signal corresponding to the position of said second chain, wherein said controller receives said first signal and said second signal and adjusts the position of said first chain relative to the position of said second chain.

24. The conveyor of claim 22 which further comprises an infeed conveyor for receiving products from said conveyor, said infeed conveyor including a moving conveying surface and a first sensor for providing a first signal corresponding to the position of said moving conveying surface, and further comprising a second sensor providing a second signal corresponding to the position of one of said first chain or said second chain, and further comprising an electronic controller operatively coupled to the one said chain, wherein said controller receives said first signal and said second signal and adjusts the position of the one said chain relative to the position of said moving conveying surface.

25. The conveyor of claim 24 wherein said first sensor is an encoder.

26. The conveyor of claim 25 wherein said second sensor is an optical sensor.

27. The conveyor of claim 22 wherein the conveying path has a length, and which further comprises means for supporting said roller shaft at a location along the length, said supporting means supporting said shaft at the location when said driving wheel engages said first chain and supporting said shaft at the location when said driving wheel engages said second chain.

28. The conveyor of claim 22 wherein said rollers are slippable on said roller shaft.

29. The conveyor of claim 22 wherein said rollers are fixed on said roller shaft.

30. The conveyor of claim 22 wherein said first manner is driving by a first motor and said second manner is driving by a second motor.

31. The conveyor of claim 30 wherein the first motor is a variable frequency drive and the second motor is a servo drive.

32. The conveyor of claim 22 wherein said first manner is driving at a first speed and said second manner is driving at a second speed different than the first speed.

33. The conveyor of claim 32 wherein the ratio of the first speed to the second speed is a substantially constant ratio.

34. The conveyor of claim 22 wherein said first manner is driving at a first speed, and said second manner is driving at substantially the first speed and said second manner includes a plurality of drive interruptions.

35. The conveyor of claim 34 wherein the plurality of drive interruptions result in a plurality of positional changes of said first chain relative to said second chain.

36. The conveyor of claim 34 wherein the second manner includes a plurality of periodic drive delays.

37. The conveyor of claim 34 wherein the interruptions include a period of driving at a faster speed.

38. The conveyor of claim 34 wherein the interruptions include a period of driving at a slower speed.

39. The conveyor of claim 34 wherein the interruptions include a period of stoppage.

40. The conveyor of claim 22 wherein the first manner is independent of the second manner.

41. A conveyor for conveying a product, comprising:
a first section of roller shafts each driving a plurality of slippable rollers, a first portion of said first section driving rollers which slip at a first predetermined torque, a second portion of said first section driving rollers which slip at a second predetermined torque, said second torque being greater than said first torque;
a second section of roller shafts, each driving a plurality of rollers fixed to a corresponding shaft of said second section, said second section adapted and configured for receiving products conveyed from said first section; and
means for stopping a product on said second portion of said first section, aid stopping means being proximate to said second section.

42. The conveyor of claim 41 wherein the second portion of said second section has a length that is less than about the length of the product.

43. The conveyor of claim 42 wherein the length of the second section is greater than about forty percent of the length of the product.

44. The conveyor of claim 41 which further comprises an infeed conveyor and a product wrapper, said infeed conveyor receiving conveyed products from said second section and providing the products to said product wrapper.

45. The conveyor of claim 41 wherein the conveying speed of the second section is more than about one and one-half the conveying speed of the first section.

46. A method for conveying products, comprising:
providing a slippable roller conveying section, a second conveying section, and a third conveying section;
conveying a plurality of products at a first speed by the slippable roller conveying section;
accumulating the plurality of products;
receiving the accumulated products from the slippable roller conveying section onto the second conveying section at a second speed less than the first speed;
transporting the accumulated products from the second conveying section onto the third conveying section; and
providing the accumulated products from the third conveying section in a predetermined spacing.

47. The method of claim 46 wherein the products are provided from the third conveying section in a first predetermined spacing, and which further comprises spacing the products on the second conveying section to a second redetermined pattern.

48. The method of claim 47 wherein the second predetermined pattern s for adjacent products to touch one another.

49. The method of claim 47 wherein the second predetermined pattern is for adjacent products to be separated from one another by roughly equivalent predetermined gaps.

50. The method of claim 46 wherein the second conveying section is a fixed roller conveying section.

51. The method of claim 46 wherein said transporting is at substantially the second speed.

52. The method of claim 46 wherein said accumulating is at least partly on the slippable roller conveying section.

53. The method of claim 46 which further comprises providing a wrapping station having product spacing requirements, and the predetermined spacing is consistent with the spacing requirements.

54. The method of claim 53 which further comprises sensing a position of the wrapping station and controlling the operation of the third conveying section in response to the signal.

55. The method of claim 54 wherein the wrapping station includes a belt and the sensed position is the position of the belt.
